(19) United States
(12) Patent Application Publication
(10) Pub. No.: US 2026/0020588 A1
(43) Pub. Date: Jan. 22, 2026

(54) Orally Administered Stimulant

(71) Applicant: Lyvwel, LLC, Miami, FL (US)

(72) Inventor: Gregory Grishayev, Miami, FL (US)

(21) Appl. No.: 18/780,460

(22) Filed: Jul. 22, 2024

(51) Int. Cl. A23L 2/60

(52) U.S. Cl. CPC A23L 2/60

(57) ABSTRACT

An orally administered stimulant. The orally administered stimulant comprising at least 30% of guarana extract; at least 0.1% of polyvinylpyrrolidone; at least 0.1% of xylitol sweetener; at least 0.1% of sucralose; at least 0.1% of natural flavoring; and at least 0.1% of mint extract, wherein the orally administered stimulant is fully mixed into a homogonous solution and dried to form a powder.

### BACKGROUND

Orally administered nicotine and caffeinated pouches are popular products designed to transfer stimulants through the lining of the mouth. Nicotine pouches provide an alternative to traditional tobacco products, and caffeinated pouches offer a quick dose of caffeine without the need of coffee or energy drinks. Both types of pouches are discreet and easy to use, making them appealing to consumers seeking quick and efficient stimulant intake.

However, these products currently have significant drawbacks. Nicotine is highly addictive, and it has been linked with increases in heart rate and blood pressure, hyperglycemia, and high levels of catecholamines in the blood. Further, orally administered nicotine has been shown to cause mouth ulcers and localized gingival recession. If nicotine pouches are administered over long periods of time, the user’s oral mucosa can also suffer from severe forms of irritation and/or inflammation. Commercially available caffeinated pouches, while less addictive and harmful, have been shown to be exceptionally bitter and foul tasting. In addition, such caffeinated pouches tend to stain the user’s teeth.

As such, there is a long felt need for an alternative to nicotine and caffeinated pouches currently available.

### SUMMARY

In some embodiments, an orally administered stimulant may contain at least 30% of guarana extract; at least 0.1% of polyvinylpyrrolidone; at least 0.1% of xylitol sweetener; at least 0.1% of sucralose; at least 0.1% of natural flavoring; and/or at least 0.1% of mint extract may be provided. In some embodiments, the orally administered stimulant may be fully mixed into a homogonous solution and dried to form a powder.

In some embodiments, the guarana extract may equal about 41.67% of the orally administered stimulant; the polyvinylpyrrolidone may equal about 33.33% of the orally administered stimulant; the xylitol sweetener may equal about 3.33% of the orally administered stimulant; the sucralose may equal about 0.33% of the orally administered stimulant; the natural flavoring may equal about 11.67% of the orally administered stimulant; and/or the mint extract may equal about 9.67% of the orally administered stimulant.

In some embodiments, the guarana extract may equal about 56.67% of the orally administered stimulant; the polyvinylpyrrolidone may equal about 20.17% of the orally administered stimulant; the xylitol sweetener may equal about 4% of the orally administered stimulant; the sucralose may equal about 0.83% of the orally administered stimulant; the natural flavoring may equal about 8.33% of the orally administered stimulant; and/or the mint extract may equal about 10% of the orally administered stimulant.

In some embodiments, the guarana extract may equal about 83.33% of the orally administered stimulant; the polyvinylpyrrolidone may equal about 0.1% of the orally administered stimulant; the xylitol sweetener may equal about 5% of the orally administered stimulant; the sucralose may equal about 1.67% of the orally administered stimulant; the natural flavoring may equal about 1.57% of the orally administered stimulant; and/or the mint extract may equal about 8.33% of the orally administered stimulant.

In some embodiments, the orally administered stimulant may also contain at least 0.1% of Vitamin B1; at least 0.1% of Vitamin B2; at least 0.1% of Vitamin B3; at least 0.1% of Vitamin B5; at least 0.1% of Vitamin B6; at least 0.01% of Vitamin B7; at least 0.01% of Vitamin B9; and/or at least 0.0001% of Vitamin B12.

In some embodiments, the guarana extract may equal about 41.67% of the orally administered stimulant; the polyvinylpyrrolidone may equal about 32.74% of the orally administered stimulant; the xylitol sweetener may equal about 3.33% of the orally administered stimulant; the sucralose may equal about 0.33% of the orally administered stimulant; the natural flavoring may equal about 11.67% of the orally administered stimulant; the mint extract may equal about 9.67% of the orally administered stimulant; the Vitamin B1 may equal about 0.11% of the orally administered stimulant; the Vitamin B2 may equal about 0.11% of the orally administered stimulant; the Vitamin B3 may equal about 0.11% of the orally administered stimulant; the Vitamin B5 may equal about 0.11% of the orally administered stimulant; the Vitamin B6 may equal about 0.11% of the orally administered stimulant; the Vitamin B7 may equal about 0.017% of the orally administered stimulant; the Vitamin B9 may equal about 0.022% of the orally administered stimulant; and/or the Vitamin B12 may equal about 0.00083% of the orally administered stimulant.

In some embodiments, the guarana extract may equal about 56.67% of the orally administered stimulant; the polyvinylpyrrolidone may equal about 19.58% of the orally administered stimulant; the xylitol sweetener may equal about 4% of the orally administered stimulant; the sucralose may equal about 0.83% of the orally administered stimulant; the natural flavoring may equal about 8.33% of the orally administered stimulant; the mint extract may equal about 10% of the orally administered stimulant; the Vitamin B1 may equal about 0.11% of the orally administered stimulant; the Vitamin B2 may equal about 0.11% of the orally administered stimulant; the Vitamin B3 may equal about 0.11% of the orally administered stimulant; the Vitamin B5 may equal about 0.11% of the orally administered stimulant; the Vitamin B6 may equal about 0.11% of the orally administered stimulant; the Vitamin B7 may equal about 0.017% of the orally administered stimulant; the Vitamin B9 may equal about 0.022% of the orally administered stimulant; and/or the Vitamin B12 may equal about 0.00083% of the orally administered stimulant.

In some embodiments, the guarana extract may equal about 83.33% of the orally administered stimulant; the polyvinylpyrrolidone may equal about 0.1% of the orally administered stimulant; the xylitol sweetener may equal about 5% of the orally administered stimulant; the sucralose may equal about 1.67% of the orally administered stimulant; the natural flavoring may equal about 0.98% of the orally administered stimulant; the mint extract may equal about 8.33% of the orally administered stimulant; the Vitamin B1 may equal about 0.11% of the orally administered stimulant; the Vitamin B2 may equal about 0.11% of the orally administered stimulant; the Vitamin B3 may equal about 0.11% of the orally administered stimulant; the Vitamin B5 may equal about 0.11% of the orally administered stimulant; the Vitamin B6 may equal about 0.11% of the orally administered stimulant; the Vitamin B7 may equal about 0.017% of the orally administered stimulant; the Vitamin B9 may equal about 0.022% of the orally administered stimulant; and/or the Vitamin B12 may equal about 0.00083% of the orally administered stimulant.

In some additional and/or alternative embodiments, an orally administered stimulant may contain at least 30% of guarana extract; at least 0.1% of microcrystalline cellulose; at least 0.1% of xylitol sweetener; at least 0.1% of sucralose; at least 0.1% of natural flavoring; and/or at least 0.1% of mint extract may be provided. In some embodiments, the orally administered stimulant may be fully mixed into a homogonous solution and dried to form a powder.

In some embodiments, the guarana extract may equal about 41.67% of the orally administered stimulant; the microcrystalline cellulose may equal about 33.33% of the orally administered stimulant; the xylitol sweetener may equal about 3.33% of the orally administered stimulant; the sucralose may equal about 0.33% of the orally administered stimulant; the natural flavoring may equal about 11.67% of the orally administered stimulant; and/or the mint extract may equal about 9.67% of the orally administered stimulant.

In some embodiments, the guarana extract may equal about 56.67% of the orally administered stimulant; the microcrystalline cellulose may equal about 20.17% of the orally administered stimulant; the xylitol sweetener may equal about 4% of the orally administered stimulant; the sucralose may equal about 0.83% of the orally administered stimulant; the natural flavoring may equal about 8.33% of the orally administered stimulant; and/or the mint extract may equal about 10% of the orally administered stimulant.

In some embodiments, the guarana extract may equal about 83.33% of the orally administered stimulant; the microcrystalline cellulose may equal about 0.1% of the orally administered stimulant; the xylitol sweetener may equal about 5% of the orally administered stimulant; the sucralose may equal about 1.67% of the orally administered stimulant; the natural flavoring may equal about 1.57% of the orally administered stimulant; and/or the mint extract may equal about 8.33% of the orally administered stimulant.

In some embodiments, the orally administered stimulant may also contain at least 0.1% of Vitamin B1; at least 0.1% of Vitamin B2; at least 0.1% of Vitamin B3; at least 0.1% of Vitamin B5; at least 0.1% of Vitamin B6; at least 0.01% of Vitamin B7; at least 0.01% of Vitamin B9; and/or at least 0.0001% of Vitamin B12.

In some embodiments, the guarana extract may equal about 41.67% of the orally administered stimulant; the microcrystalline cellulose may equal about 32.74% of the orally administered stimulant; the xylitol sweetener may equal about 3.33% of the orally administered stimulant; the sucralose may equal about 0.33% of the orally administered stimulant; the natural flavoring may equal about 11.67% of the orally administered stimulant; the mint extract may equal about 9.67% of the orally administered stimulant; the Vitamin B1 may equal about 0.11% of the orally administered stimulant; the Vitamin B2 may equal about 0.11% of the orally administered stimulant; the Vitamin B3 may equal about 0.11% of the orally administered stimulant; the Vitamin B5 may equal about 0.11% of the orally administered stimulant; the Vitamin B6 may equal about 0.11% of the orally administered stimulant; the Vitamin B7 may equal about 0.017% of the orally administered stimulant; the Vitamin B9 may equal about 0.022% of the orally administered stimulant; and/or the Vitamin B12 may equal about 0.00083% of the orally administered stimulant.

In some embodiments, the guarana extract may equal about 56.67% of the orally administered stimulant; the microcrystalline cellulose may equal about 19.58% of the orally administered stimulant; the xylitol sweetener may equal about 4% of the orally administered stimulant; the sucralose may equal about 0.83% of the orally administered stimulant; the natural flavoring may equal about 8.33% of the orally administered stimulant; the mint extract may equal about 10% of the orally administered stimulant; the Vitamin B1 may equal about 0.11% of the orally administered stimulant; the Vitamin B2 may equal about 0.11% of the orally administered stimulant; the Vitamin B3 may equal about 0.11% of the orally administered stimulant; the Vitamin B5 may equal about 0.11% of the orally administered stimulant; the Vitamin B6 may equal about 0.11% of the orally administered stimulant; the Vitamin B7 may equal about 0.017% of the orally administered stimulant; the Vitamin B9 may equal about 0.022% of the orally administered stimulant; and/or the Vitamin B12 may equal about 0.00083% of the orally administered stimulant.

In some embodiments, the guarana extract may equal about 83.33% of the orally administered stimulant; the microcrystalline cellulose may equal about 0.1% of the orally administered stimulant; the xylitol sweetener may equal about 5% of the orally administered stimulant; the sucralose may equal about 1.67% of the orally administered stimulant; the natural flavoring may equal about 0.98% of the orally administered stimulant; the mint extract may equal about 8.33% of the orally administered stimulant; the Vitamin B1 may equal about 0.11% of the orally administered stimulant; the Vitamin B2 may equal about 0.11% of the orally administered stimulant; the Vitamin B3 may equal about 0.11% of the orally administered stimulant; the Vitamin B5 may equal about 0.11% of the orally administered stimulant; the Vitamin B6 may equal about 0.11% of the orally administered stimulant; the Vitamin B7 may equal about 0.017% of the orally administered stimulant; the Vitamin B9 may equal about 0.022% of the orally administered stimulant; and/or the Vitamin B12 may equal about 0.00083% of the orally administered stimulant.

In some embodiments, the powder form of the orally administered stimulant may be encased in a water insoluble pouch, the water insoluble pouch may be permeable for saliva, and the water insoluble pouch may be made from non-toxic viscose.

In some embodiments, the orally administered stimulant, when orally administered to a user, may freshen the user’s breath and may not stain the user’s teeth.

Advantages will become more apparent to those of ordinary skill in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various embodiments of the systems and methods disclosed herein. It should be understood that the figures depict illustrative embodiments of the disclosure and that the figures are intended to be exemplary in nature. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1 depicts an exemplary orally administered stimulant;

FIG. 2 depicts a first set of ingredients of the stimulant compound;

FIG. 3A depicts a first recipe of the stimulant compound using the first set of ingredients;

FIG. 3B depicts a second recipe of the stimulant compound using the first set of ingredients;

FIG. 3C depicts a third recipe of the stimulant compound using the first set of ingredients;

FIG. 3D depicts a fourth recipe of the stimulant compound using the first set of ingredients;

FIG. 3E depicts a fifth recipe of the stimulant compound using the first set of ingredients;

FIG. 3F depicts a sixth recipe of the stimulant compound using the first set of ingredients;

FIG. 3G depicts a seventh recipe of the stimulant compound using the first set of ingredients;

FIG. 3H depicts an eighth recipe of the stimulant compound using the first set of ingredients;

FIG. 4 depicts a second set of ingredients of the stimulant compound;

FIG. 5A depicts a nineth recipe of the stimulant compound using the second set of ingredients;

FIG. 5B depicts a tenth recipe of the stimulant compound using the second set of ingredients;

FIG. 5C depicts an eleventh recipe of the stimulant compound using the second set of ingredients;

FIG. 5D depicts a twelfth recipe of the stimulant compound using the second set of ingredients;

FIG. 5E depicts a thirteenth recipe of the stimulant compound using the second set of ingredients;

FIG. 5F depicts a fourteenth recipe of the stimulant compound using the second set of ingredients;

FIG. 5G depicts a fifteenth recipe of the stimulant compound using the second set of ingredients; and

FIG. 5H depicts a sixteenth recipe of the stimulant compound using the second set of ingredients.

The figures depict the present embodiments for purposes of illustration only. One skilled in the art will readily recognize from the following discussion that alternate embodiments of the structures and methods illustrated herein may be employed without departing from the principles of the invention described herein.

### DETAILED DESCRIPTION

### INTRODUCTION

The present description discloses several embodiments of orally administered stimulants. The orally administered stimulants described herein may include an amount of guarana extract, selected sweeteners, and a cooling agent among other ingredients.

Guarana extract, in addition to caffeine, has many additional benefits. For example, guarana extract contains compounds like theobromine and theophylline, which contribute to cognitive and energy-boosting effects beyond typical caffeine stimulation.

However, guarana has an extremely displeasing taste and is more bitter than most forms of black coffee. To leverage guarana as a viable active ingredient of the orally administered stimulant, much trial and error was conducted to determine ingredients, in the right amounts, counteract the guarana’s natural flavor. In particular, as noted above the orally administer stimulant may include selected sweeteners (such as sucralose and xylitol), and a cooling agent (such as mint extract, menthol, peppermint, or eucalyptus oil) extract to counteract the bitterness of the guarana extract and provide a cooling. The introduction of a cooling agent creates a refreshing or soothing effect on the skin or mucous membranes of the mouth which helps disguise the bitterness of the guarana extract.

After much experimentation, the identification of these and other ingredients, as well as their amounts, were discovered and are disclosed herein in the following recipes.

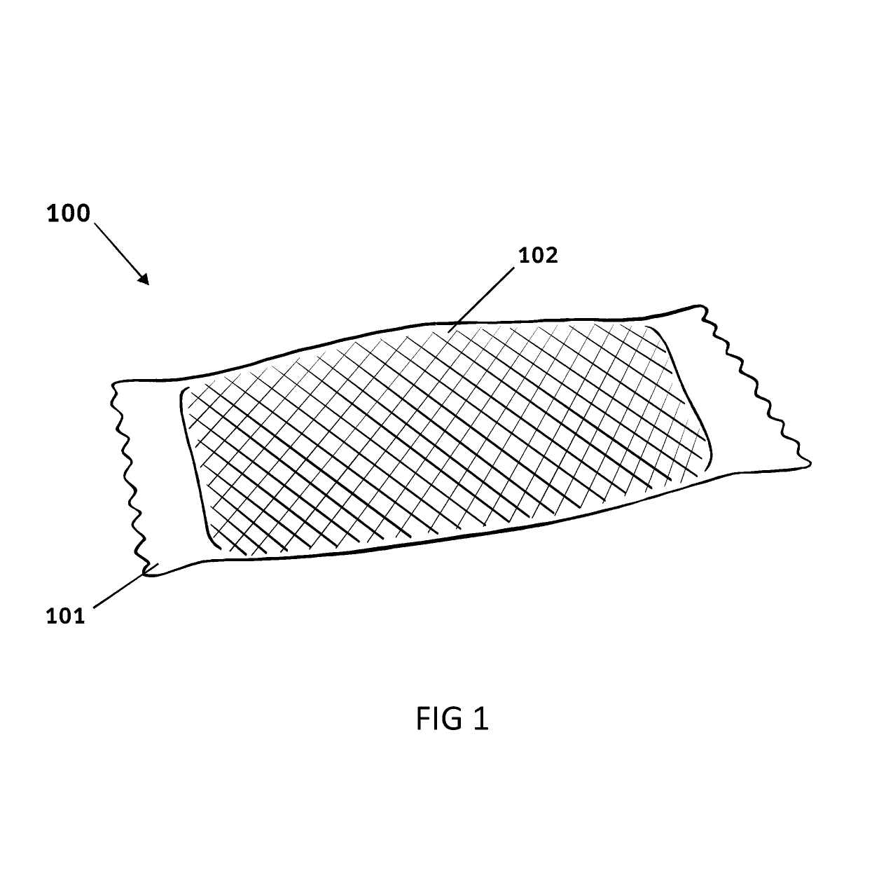

As illustrated in FIG. 1, an orally administered stimulant 100 may include a water insoluble pouch 101 to hold a stimulant compound 102.

The water insoluble pouch 101 may be made from non-toxic viscose and the may be made from non-toxic viscose may be permeable for saliva.

The stimulant compound 102 may be a composition in accordance with one of the recipes described below. It should be noted that additional and/or alternative recipes not explicitly described herein are contemplated. Once the ingredients of the stimulant compound 102 are assembled, the ingredients of the stimulant compound 102 may be fully mixed into a homogonous solution and dried to form a powder. In some embodiments, the powder form of the stimulant compound 102 may be fully encased in the water insoluble pouch 101.

In operation, a user may place the water insoluble pouch 101 containing the powder form of the stimulant compound 102 into their mouth between their upper or lower lips and adjacent gums. The powder form of the stimulant compound 102 may be activated by the user’s saliva in which case the stimulant compound 102 is absorbed through the user’s oral mucosa into the user’s bloodstream. From there, the delivery of caffeine travels up the central nervous system and acts as an antagonist to adenosine. As will be made clear to a person having skill in the art, the stimulant compound 102, having the ingredients described herein, when activated by the user’s saliva, may freshen the user’s breath and may not stain the user’s teeth. In some embodiments, the activation of the stimulant compound 102 may cause a tingling sensation, a cooling sensation, or a burning sensation.

### EXAMPLE RECIPES

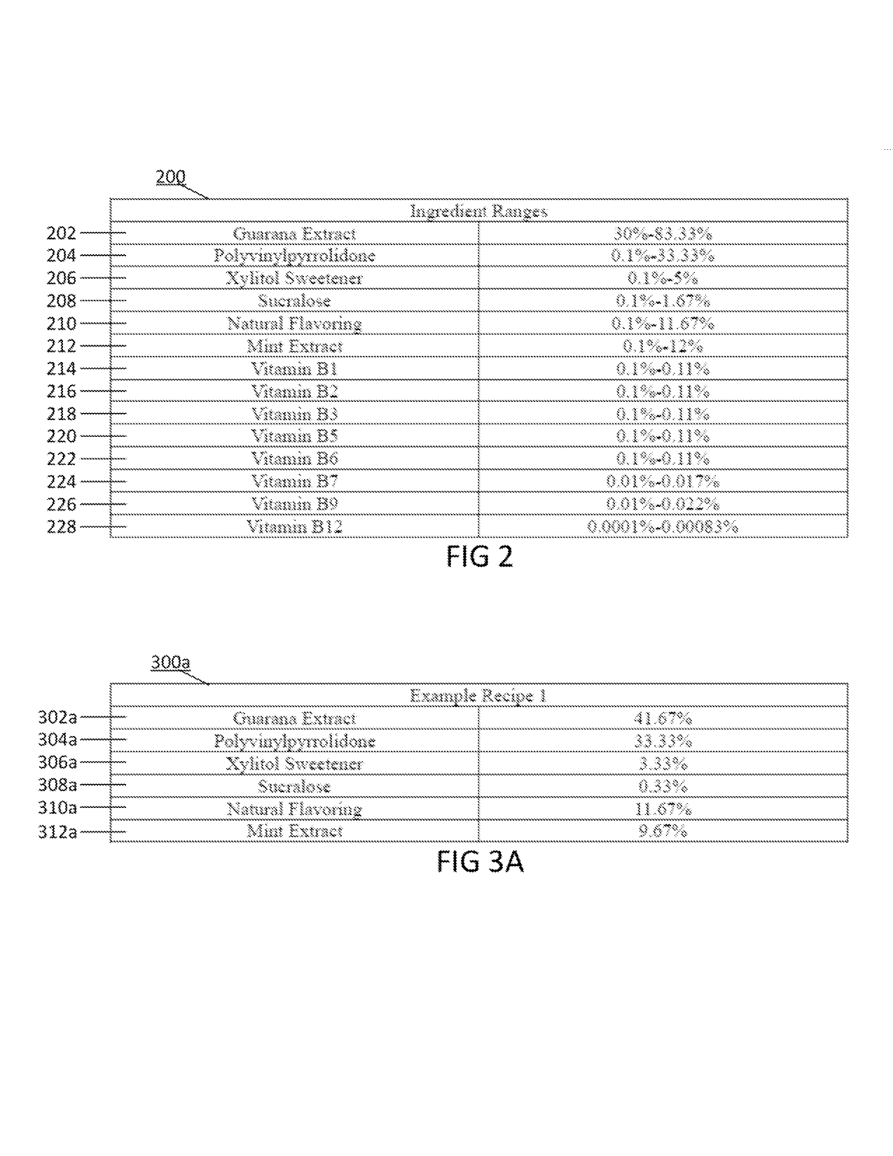

As an illustrative example, FIG. 2 depicts a first set of ingredients 200 of the stimulant compound 102. In particular, the first set of ingredients 200, may include guarana extract 202, polyvinylpyrrolidone 204, xylitol sweetener 206, sucralose 208, natural flavoring 210, mint extract 212, Vitamin B1 214, Vitamin B2 216, Vitamin B3 218, Vitamin B5 220, Vitamin B6 222, Vitamin B7 224, Vitamin B9 226, and/or Vitamin B12 228. Additional and/or alternative ingredients to the first set of ingredients 200, such as compounds from the methyl group, are contemplated.

The guarana extract 202 may be a water-soluble extract from the seeds of the plant paullinia cupana. The polyvinylpyrrolidone 204 may be water-soluble polymer made from the monomer N-vinylpyrrolidone and may have the chemical formula (C₆H₉NO)ₙ. The xylitol sweetener 206 may be a food sweetener with the primary ingredient being xylitol which may have the chemical formula C₅H₁₂O₅. The sucralose 208 may be a food sweetener which may have the chemical formula C₁₂H₁₉Cₗ₃O₈. The natural flavoring 210 may be any combination of spices (e.g., sea-salt, black pepper, basil, ginger, thyme, etc.), spice extracts, essential oils, oleoresins, vegetable powders (e.g., onion powder, garlic powder, celery powder, etc.), and/or fruit and vegetable juices (e.g., lemon juice, lime juice, orange juice, carrot juice, onion juice, garlic juice, etc.) that are approved to be labelled as natural flavoring 210 by the United States Food and Drug Administration. The mint extract 212 may be a water-soluble extract from the mentha genus of plants. The Vitamin B1 214 may be a micronutrient with the chemical formula C₁₂H₁₇N₄OS⁺. The Vitamin B2 216 may be a micronutrient with the chemical formula C₁₇H₂₀N₄O₆. The Vitamin B3 218 may be a micronutrient with the chemical formula C₆H₅NO₂. The Vitamin B5 220 may be a micronutrient with the chemical formula C₉H₁₇NO₅. The Vitamin B6 222 may be a micronutrient with the chemical formula C₈H₁₁NO₃. The Vitamin B7 224 may be a micronutrient with the chemical formula C₁₀H₁₆N₂O₃S. The Vitamin B9 226 may be a micronutrient with the chemical formula C₁₉H₁₉N₇O₆. The Vitamin B12 228 may be a micronutrient with the chemical formula C₆₃H₈₈CoN₁₄O₁₄P.

As illustrated in FIG. 2, the guarana extract 202 may be about 30% to 83.33% of the total composition of the stimulant compound 102, the polyvinylpyrrolidone 204 may be about 0.1% to 33.33% of the total composition of the stimulant compound 102, the xylitol sweetener 206 may be about 0.1% to 5% of the total composition of the stimulant compound 102, the sucralose 208 may be about 0.1% to 1.67% of the total composition of the stimulant compound 102, the natural flavoring 210 may be about 0.1% to 11.67% of the total composition of the stimulant compound 102, the mint extract 212 may be about 0.1% to 12% of the total composition of the stimulant compound 102, the Vitamin B1 214 may be about 0.1% to 0.11% of the total composition of the stimulant compound 102, the Vitamin B2 216 may be about 0.1% to 0.11% of the total composition of the stimulant compound 102, the Vitamin B3 218 may be about 0.1% to 0.11% of the total composition of the stimulant compound 102, the Vitamin B5 220 may be about 0.1% to 0.11% of the total composition of the stimulant compound 102, the Vitamin B6 222 may be about 0.1% to 0.11% of the total composition of the stimulant compound 102, the Vitamin B7 224 may be about 0.01% to 0.017% of the total composition of the stimulant compound 102, the Vitamin B9 226 may be about 0.01% to 0.022% of the total composition of the stimulant compound 102, and/or the Vitamin B12 228 may be about 0.0001% to 0.00083% of the total composition of the stimulant compound 102.

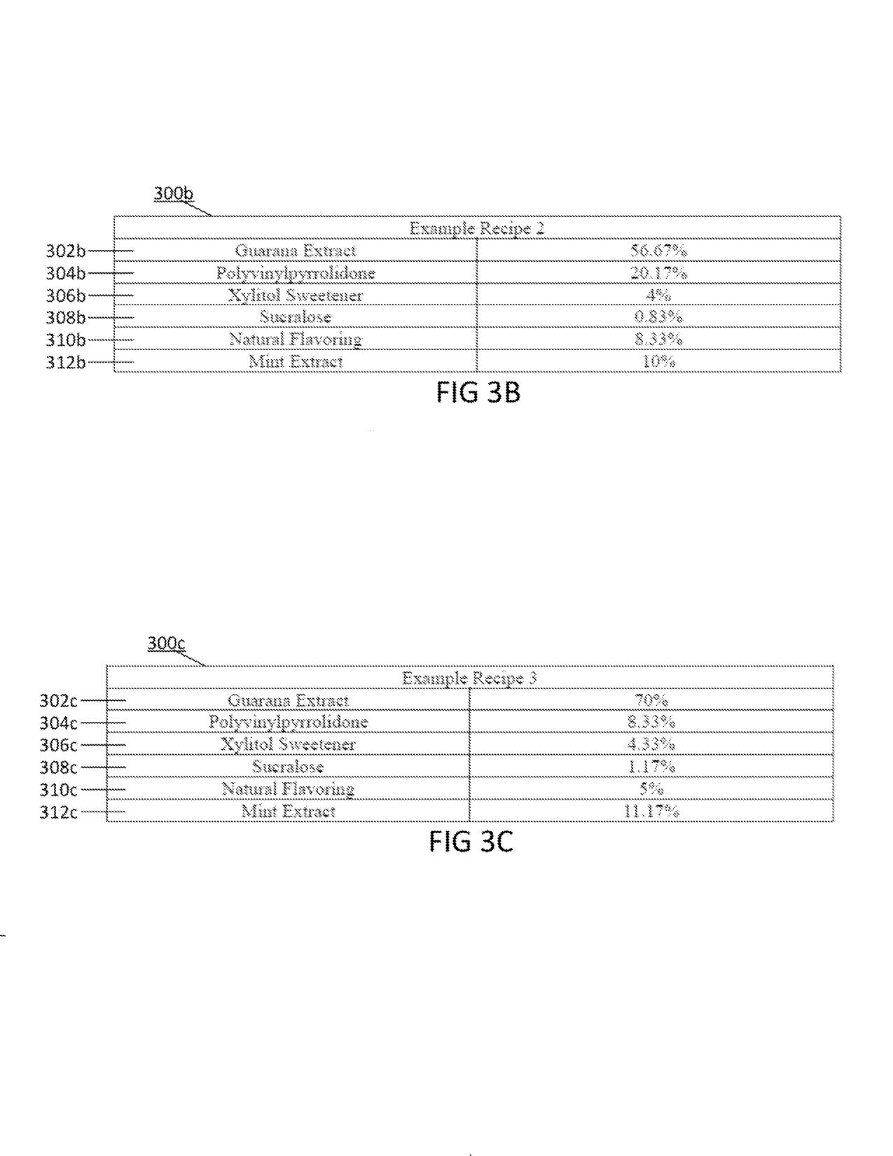

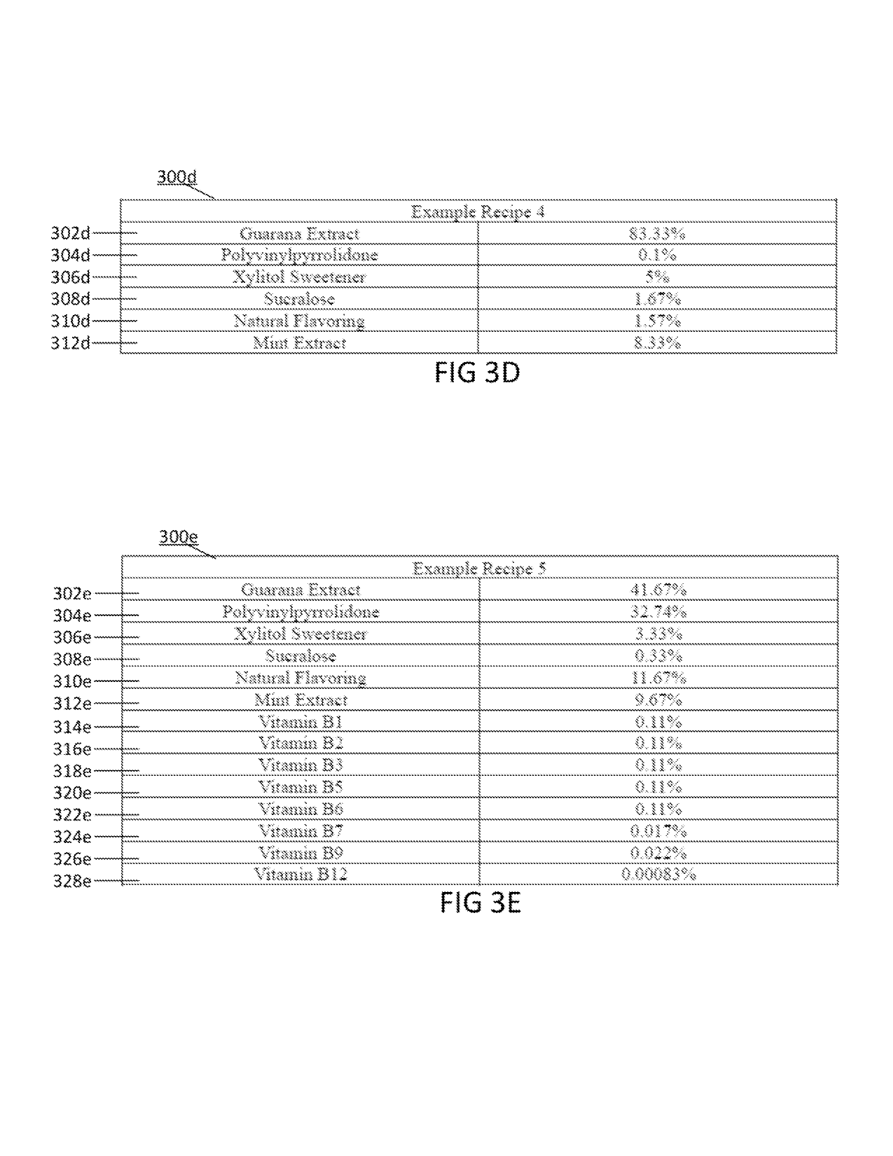

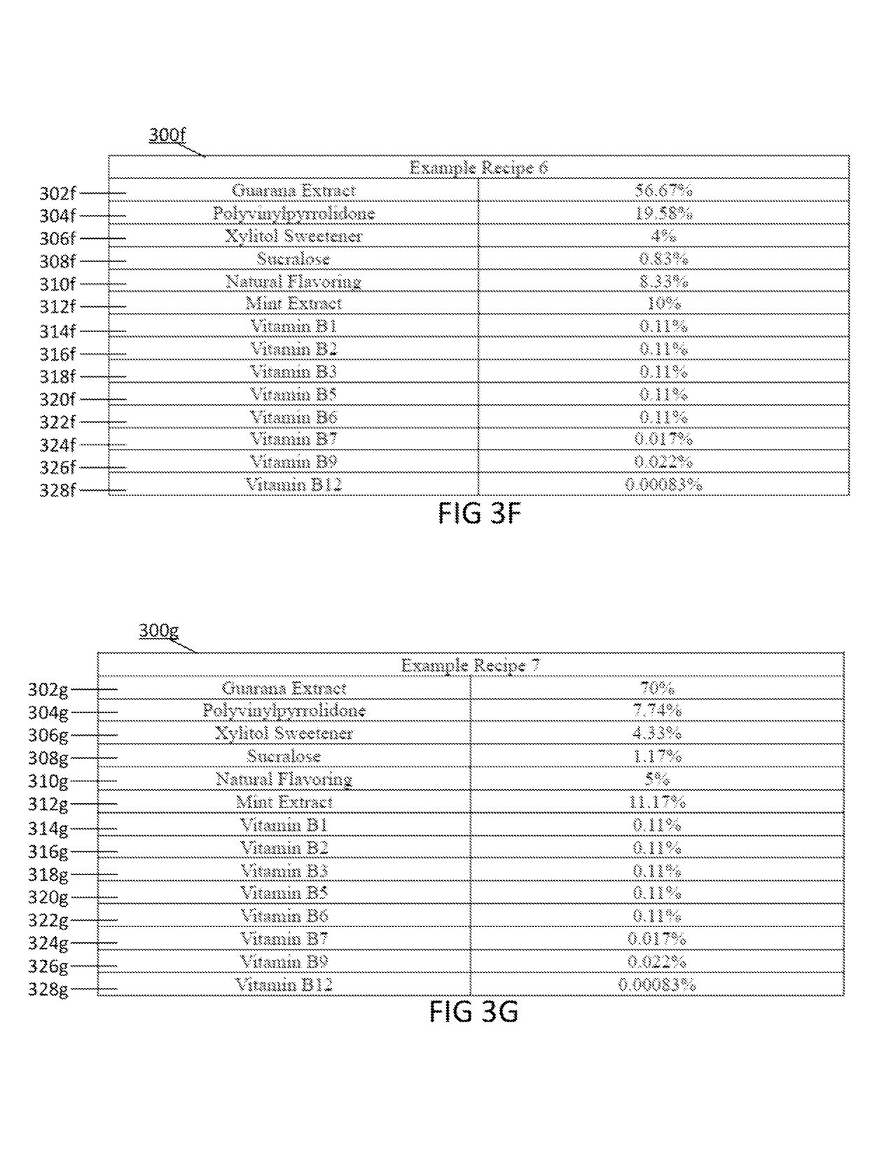

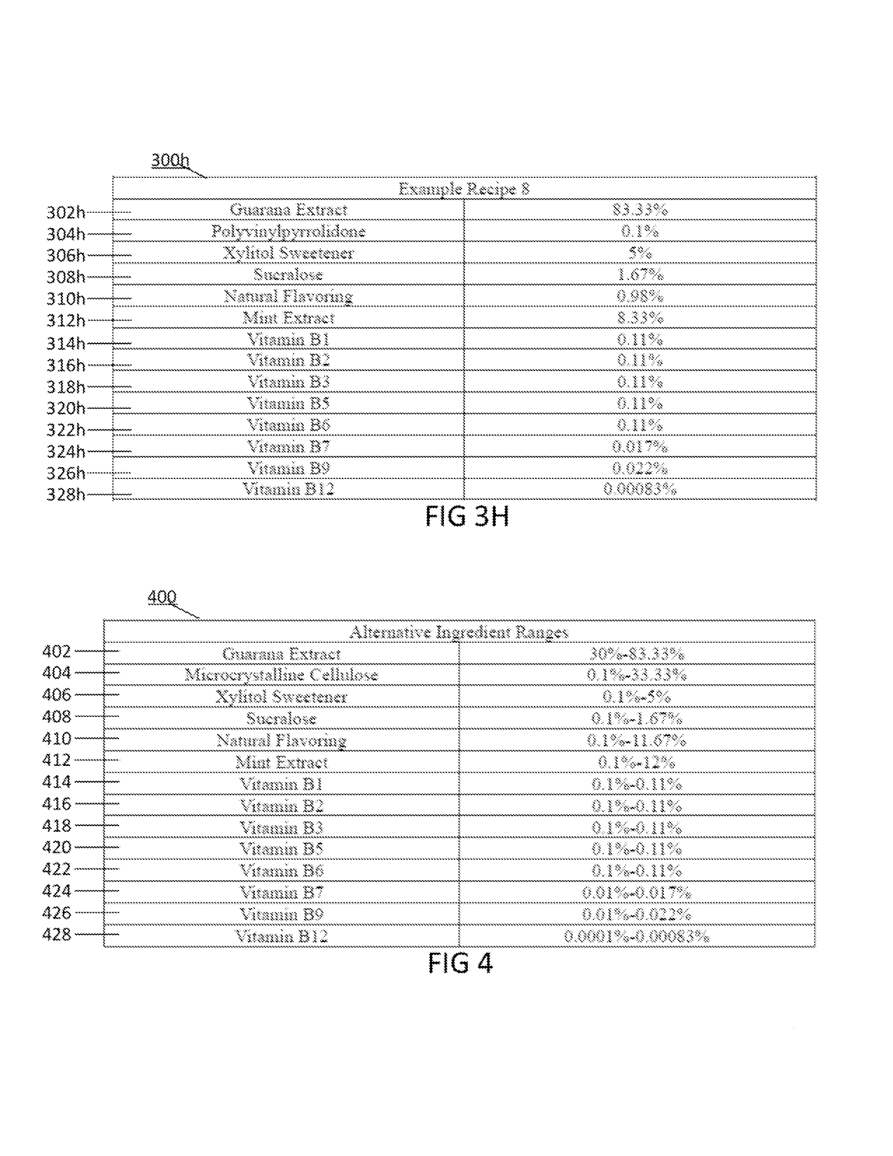

FIGS. 3A-3H depict a series of example recipes 300a, 300b, 300c, 300d, 300e, 300f, 300g, and 300h using the first set of ingredients 200.

As illustrated in FIG. 3A, a first example recipe 300a may include guarana extract 302a at about 41.67% of the total composition of the stimulant compound 102, polyvinylpyrrolidone 304a at about 33.33% of the total composition of the stimulant compound 102, xylitol sweetener 306a at about 3.33% of the total composition of the stimulant compound 102, sucralose 308a at about 0.33% of the total composition of the stimulant compound 102, natural flavoring 310a at about 11.67% of the total composition of the stimulant compound 102, and mint extract 312a at about 9.67% of the total composition of the stimulant compound 102.

As an illustrative example, an orally administered stimulant 100 following the first example recipe 300a may have a total dry weight of about 600mg. Under the first example recipe 300a, the guarana extract 302a would be about 250mg of the total dry weight of the stimulant compound 102, the polyvinylpyrrolidone 304a would be about 200mg of the total dry weight of the stimulant compound 102, the xylitol sweetener 306a would be about 20mg of the total dry weight of the stimulant compound 102, the sucralose 308a would be about 2mg of the total dry weight of the stimulant compound 102, the natural flavoring 310a would be about 70mg of the total dry weight of the stimulant compound 102, and the mint extract 312a at about 58mg of the total dry weight of the stimulant compound 102.

As illustrated in FIG. 3B, a second example recipe 300b may include guarana extract 302b at about 56.67% of the total composition of the stimulant compound 102, polyvinylpyrrolidone 304b at about 20.17% of the total composition of the stimulant compound 102, xylitol sweetener 306b at about 4% of the total composition of the stimulant compound 102, sucralose 308b at about 0.83% of the total composition of the stimulant compound 102, natural flavoring 310b at about 8.33% of the total composition of the stimulant compound 102, and mint extract 312b at about 10% of the total composition of the stimulant compound 102.

As an illustrative example, an orally administered stimulant 100 following the second example recipe 300b may have a total dry weight of about 600mg. Under the second example recipe 300b, the guarana extract 302b would be about 340mg of the total dry weight of the stimulant compound 102, the polyvinylpyrrolidone 304b would be about 121mg of the total dry weight of the stimulant compound 102, the xylitol sweetener 306b would be about 24mg of the total dry weight of the stimulant compound 102, the sucralose 308b would be about 5mg of the total dry weight of the stimulant compound 102, the natural flavoring 310b would be about 50mg of the total dry weight of the stimulant compound 102, and the mint extract 312b at about 60mg of the total dry weight of the stimulant compound 102.

As illustrated in FIG. 3C, a third example recipe 300c may include guarana extract 302c at about 70% of the total composition of the stimulant compound 102, polyvinylpyrrolidone 304c at about 8.33% of the total composition of the stimulant compound 102, xylitol sweetener 306c at about 4.33% of the total composition of the stimulant compound 102, sucralose 308c at about 1.17% of the total composition of the stimulant compound 102, natural flavoring 310c at about 5% of the total composition of the stimulant compound 102, and mint extract 312c at about 11.17% of the total composition of the stimulant compound 102.

As an illustrative example, an orally administered stimulant 100 following the third example recipe 300c may have a total dry weight of about 600mg. Under the third example recipe 300c, the guarana extract 302c would be about 420mg of the total dry weight of the stimulant compound 102, the polyvinylpyrrolidone 304c would be about 50mg of the total dry weight of the stimulant compound 102, the xylitol sweetener 306c would be about 26mg of the total dry weight of the stimulant compound 102, the sucralose 308c would be about 7mg of the total dry weight of the stimulant compound 102, the natural flavoring 310c would be about 30mg of the total dry weight of the stimulant compound 102, and the mint extract 312c at about 67mg of the total dry weight of the stimulant compound 102.

As illustrated in FIG. 3D, a fourth example recipe 300d may include guarana extract 302d at about 83.33% of the total composition of the stimulant compound 102, polyvinylpyrrolidone 304d at about 0.1% of the total composition of the stimulant compound 102, xylitol sweetener 306d at about 5% of the total composition of the stimulant compound 102, sucralose 308d at about 1.67% of the total composition of the stimulant compound 102, natural flavoring 310d at about 1.57% of the total composition of the stimulant compound 102, and mint extract 312d at about 8.33% of the total composition of the stimulant compound 102.

As an illustrative example, an orally administered stimulant 100 following the fourth example recipe 300d may have a total dry weight of about600 mg. Under the fourth example recipe 300d, the guarana extract 302d would be about 500mg of the total dry weight of the stimulant compound 102, the polyvinylpyrrolidone 304d would be about 0.6mg of the total dry weight of the stimulant compound 102, the xylitol sweetener 306d would be about 30 mg of the total dry weight of the stimulant compound 102, the sucralose 308d would be about 10 mg of the total dry weight of the stimulant compound 102, the natural flavoring 310d would be about 9.4mg of the total dry weight of the stimulant compound 102, and the mint extract 312d at about 50mg of the total dry weight of the stimulant compound 102.

As illustrated in FIG. 3E, a fifth example recipe 300e may include guarana extract 302e at about 41.67% of the total composition of the stimulant compound 102, polyvinylpyrrolidone 304e at about 32.74% of the total composition of the stimulant compound 102, xylitol sweetener 306e at about 3.33% of the total composition of the stimulant compound 102, sucralose 308e at about 0.33% of the total composition of the stimulant compound 102, natural flavoring 310e at about 11.67% of the total composition of the stimulant compound 102, mint extract 312e at about 9.67% of the total composition of the stimulant compound 102, Vitamin B1 314e at about 0.11% of the total composition of the stimulant compound 102, Vitamin B2 316e at about 0.11% of the total composition of the stimulant compound 102, Vitamin B3 318e at about 0.11% of the total composition of the stimulant compound 102, Vitamin B5 320e at about 0.11% of the total composition of the stimulant compound 102, Vitamin B6 322e at about 0.11% of the total composition of the stimulant compound 102, Vitamin B7 324e at about 0.017% of the total composition of the stimulant compound 102, Vitamin B9 326e at about 0.022% of the total composition of the stimulant compound 102, and Vitamin B12 328e at about 0.00083% of the total composition of the stimulant compound 102.

As an illustrative example, an orally administered stimulant 100 following the fifth example recipe 300e may have a total dry weight of about 600 mg. Under the fifth example recipe 300e, the guarana extract 302e would be about 250 mg of the total dry weight of the stimulant compound 102, the polyvinylpyrrolidone 304e would be about 196.45mg of the total dry weight of the stimulant compound 102, the xylitol sweetener 306e would be about 20mg of the total dry weight of the stimulant compound 102, the sucralose 308e would be about 2mg of the total dry weight of the stimulant compound 102, the natural flavoring 310e would be about 70 mg of the total dry weight of the stimulant compound 102, the mint extract 312e at about 58mg of the total dry weight of the stimulant compound 102, the Vitamin B1 314e at about 0.66mg of the total composition of the stimulant compound 102, the Vitamin B2 316e at about 0.66mg of the total composition of the stimulant compound 102, the Vitamin B3 318e at about 0.66mg of the total composition of the stimulant compound 102, the Vitamin B5 320e at about 0.66mg of the total composition of the stimulant compound 102, the Vitamin B6 322e at about 0.66mg of the total composition of the stimulant compound 102, the Vitamin B7 324e at about 0.1mg of the total composition of the stimulant compound 102, the Vitamin B9 326e at about 0.132mg of the total composition of the stimulant compound 102, and the Vitamin B12 328e at about5 mcg of the total composition of the stimulant compound 102.

As illustrated in FIG. 3F, a sixth example recipe 300f may include guarana extract 302f at about 56.67% of the total composition of the stimulant compound 102, polyvinylpyrrolidone 304f at about 19.58% of the total composition of the stimulant compound 102, xylitol sweetener 306f at about 4% of the total composition of the stimulant compound 102, sucralose 308f at about 0.83% of the total composition of the stimulant compound 102, natural flavoring 310f at about 8.33% of the total composition of the stimulant compound 102, mint extract 312f at about 10% of the total composition of the stimulant compound 102, Vitamin B1 314f at about 0.11% of the total composition of the stimulant compound 102, Vitamin B2 316f at about 0.11% of the total composition of the stimulant compound 102, Vitamin B3 318f at about 0.11% of the total composition of the stimulant compound 102, Vitamin B5 320f at about 0.11% of the total composition of the stimulant compound 102, Vitamin B6 322f at about 0.11% of the total composition of the stimulant compound 102, Vitamin B7 324f at about 0.017% of the total composition of the stimulant compound 102, Vitamin B9 326f at about 0.022% of the total composition of the stimulant compound 102, and Vitamin B12 328f at about 0.00083% of the total composition of the stimulant compound 102.

As an illustrative example, an orally administered stimulant 100 following the sixth example recipe 300f may have a total dry weight of about 600mg. Under the sixth example recipe 300f, the guarana extract 302f would be about 340 mg of the total dry weight of the stimulant compound 102, the polyvinylpyrrolidone 304f would be about 117.48mg of the total dry weight of the stimulant compound 102, the xylitol sweetener 306f would be about 24 mg of the total dry weight of the stimulant compound 102, the sucralose 308f would be about 5 mg of the total dry weight of the stimulant compound 102, the natural flavoring 310f would be about 50 mg of the total dry weight of the stimulant compound 102, the mint extract 312f at about 60 mg of the total dry weight of the stimulant compound 102, the Vitamin B1 314f at about 0.66mg of the total composition of the stimulant compound 102, the Vitamin B2 316f at about 0.66mg of the total composition of the stimulant compound 102, the Vitamin B3 318f at about 0.66mg of the total composition of the stimulant compound 102, the Vitamin B5 320f at about 0.66mg of the total composition of the stimulant compound 102, the Vitamin B6 322f at about 0.66mg of the total composition of the stimulant compound 102, the Vitamin B7 324f at about 0.1mg of the total composition of the stimulant compound 102, the Vitamin B9 326f at about 0.132mg of the total composition of the stimulant compound 102, and the Vitamin B12 328f at about 5 mcg of the total composition of the stimulant compound 102.

As illustrated in FIG. 3G, a seventh example recipe 300g may include guarana extract 302g at about 70% of the total composition of the stimulant compound 102, polyvinylpyrrolidone 304g at about 7.74% of the total composition of the stimulant compound 102, xylitol sweetener 306g at about 4.33% of the total composition of the stimulant compound 102, sucralose 308g at about 1.17% of the total composition of the stimulant compound 102, natural flavoring 310g at about 5% of the total composition of the stimulant compound 102, mint extract 312g at about 11.17% of the total composition of the stimulant compound 102, Vitamin B1 314g at about 0.11% of the total composition of the stimulant compound 102, Vitamin B2 316g at about 0.11% of the total composition of the stimulant compound 102, Vitamin B3 318g at about 0.11% of the total composition of the stimulant compound 102, Vitamin B5 320g at about 0.11% of the total composition of the stimulant compound 102, Vitamin B6 322g at about 0.11% of the total composition of the stimulant compound 102, Vitamin B7 324g at about 0.017% of the total composition of the stimulant compound 102, Vitamin B9 326 g at about 0.022% of the total composition of the stimulant compound 102, and Vitamin B12 328g at about 0.00083% of the total composition of the stimulant compound 102.

As an illustrative example, an orally administered stimulant 100 following the seventh example recipe 300g may have a total dry weight of about 600 mg. Under the seventh example recipe 300g, the guarana extract 302g would be about 420 mg of the total dry weight of the stimulant compound 102, the polyvinylpyrrolidone 304g would be about 46.44mg of the total dry weight of the stimulant compound 102, the xylitol sweetener 306g would be about 26mg of the total dry weight of the stimulant compound 102, the sucralose 308g would be about 7 mg of the total dry weight of the stimulant compound 102, the natural flavoring 310g would be about 30 mg of the total dry weight of the stimulant compound 102, the mint extract 312g at about 67 mg of the total dry weight of the stimulant compound 102, the Vitamin B1 314g at about 0.66mg of the total composition of the stimulant compound 102, the Vitamin B2 316g at about 0.66mg of the total composition of the stimulant compound 102, the Vitamin B3 318g at about 0.66mg of the total composition of the stimulant compound 102, the Vitamin B5 320g at about 0.66mg of the total composition of the stimulant compound 102, the Vitamin B6 322g at about 0.66mg of the total composition of the stimulant compound 102, the Vitamin B7 324g at about 0.1mg of the total composition of the stimulant compound 102, the Vitamin B9 326g at about 0.132mg of the total composition of the stimulant compound 102, and the Vitamin B12 328g at about 5 mcg of the total composition of the stimulant compound 102.

As illustrated in FIG. 3H, an eighth example recipe 300h may include guarana extract 302h at about 83.33% of the total composition of the stimulant compound 102, polyvinylpyrrolidone 304h at about 0.1% of the total composition of the stimulant compound 102, xylitol sweetener 306h at about 5% of the total composition of the stimulant compound 102, sucralose 308h at about 1.67% of the total composition of the stimulant compound 102, natural flavoring 310h at about 0.98% of the total composition of the stimulant compound 102, mint extract 312h at about 8.33% of the total composition of the stimulant compound 102, Vitamin B1 314h at about 0.11% of the total composition of the stimulant compound 102, Vitamin B2 316h at about 0.11% of the total composition of the stimulant compound 102, Vitamin B3 318h at about 0.11% of the total composition of the stimulant compound 102, Vitamin B5 320h at about 0.11% of the total composition of the stimulant compound 102, Vitamin B6 322h at about 0.11% of the total composition of the stimulant compound 102, Vitamin B7 324h at about 0.017% of the total composition of the stimulant compound 102, Vitamin B9 326h at about 0.022% of the total composition of the stimulant compound 102, and Vitamin B12 328h at about 0.00083% of the total composition of the stimulant compound 102.

As an illustrative example, an orally administered stimulant 100 following the eighth example recipe 300h may have a total dry weight of about 600mg. Under the eighth example recipe 300h, the guarana extract 302h would be about 500mg of the total dry weight of the stimulant compound 102, the polyvinylpyrrolidone 304h would be about 0.6mg of the total dry weight of the stimulant compound 102, the xylitol sweetener 306h would be about 30mg of the total dry weight of the stimulant compound 102, the sucralose 308h would be about 10mg of the total dry weight of the stimulant compound 102, the natural flavoring 310h would be about 5.88mg of the total dry weight of the stimulant compound 102, the mint extract 312h at about 50mg of the total dry weight of the stimulant compound 102, the Vitamin B1 314h at about 0.66mg of the total composition of the stimulant compound 102, the Vitamin B2 316h at about 0.66mg of the total composition of the stimulant compound 102, the Vitamin B3 318h at about 0.66mg of the total composition of the stimulant compound 102, the Vitamin B5 320h at about 0.66mg of the total composition of the stimulant compound 102, the Vitamin B6 322h at about 0.66mg of the total composition of the stimulant compound 102, the Vitamin B7 324h at about 0.1mg of the total composition of the stimulant compound 102, the Vitamin B9 326h at about 0.132mg of the total composition of the stimulant compound 102, and the Vitamin B12 328h at about 5mcg of the total composition of the stimulant compound 102.

As another illustrative example, FIG. 4 depicts a second set of ingredients 400 of the stimulant compound 102. In particular, the second set of ingredients 400, may include guarana extract 402, microcrystalline cellulose 404, xylitol sweetener 406, sucralose 408, natural flavoring 410, mint extract 412, Vitamin B1 414, Vitamin B2 416, Vitamin B3 418, Vitamin B5 420, Vitamin B6 422, Vitamin B7 424, Vitamin B9 426, and/or Vitamin B12 428. Additional and/or alternative ingredients to the second set of ingredients 400, such as compounds from the methyl group, are contemplated.

The microcrystalline cellulose 404 may be water-soluble polymer made from one or more chains of glucose units that may form a crystalline structure.

As illustrated in FIG. 4, the guarana extract 402 may be about 30% to 83.33% of the total composition of the stimulant compound 102, the microcrystalline cellulose 404 may be about 0.1% to 33.33% of the total composition of the stimulant compound 102, the xylitol sweetener 406 may be about 0.1% to 5% of the total composition of the stimulant compound 102, the sucralose 408 may be about 0.1% to 1.67% of the total composition of the stimulant compound 102, the natural flavoring 410 may be about 0.1% to 11.67% of the total composition of the stimulant compound 102, the mint extract 412 may be about 0.1% to 12% of the total composition of the stimulant compound 102, the Vitamin B1 414 may be about 0.1% to 0.11% of the total composition of the stimulant compound 102, the Vitamin B2 416 may be about 0.1% to 0.11% of the total composition of the stimulant compound 102, the Vitamin B3 418 may be about 0.1% to 0.11% of the total composition of the stimulant compound 102, the Vitamin B5 420 may be about 0.1% to 0.11% of the total composition of the stimulant compound 102, the Vitamin B6 422 may be about 0.1% to 0.11% of the total composition of the stimulant compound 102, the Vitamin B7 424 may be about 0.01% to 0.017% of the total composition of the stimulant compound 102, the Vitamin B9 426 may be about 0.01% to 0.022% of the total composition of the stimulant compound 102, and/or the Vitamin B12 428 may be about 0.0001% to 0.00083% of the total composition of the stimulant compound 102.

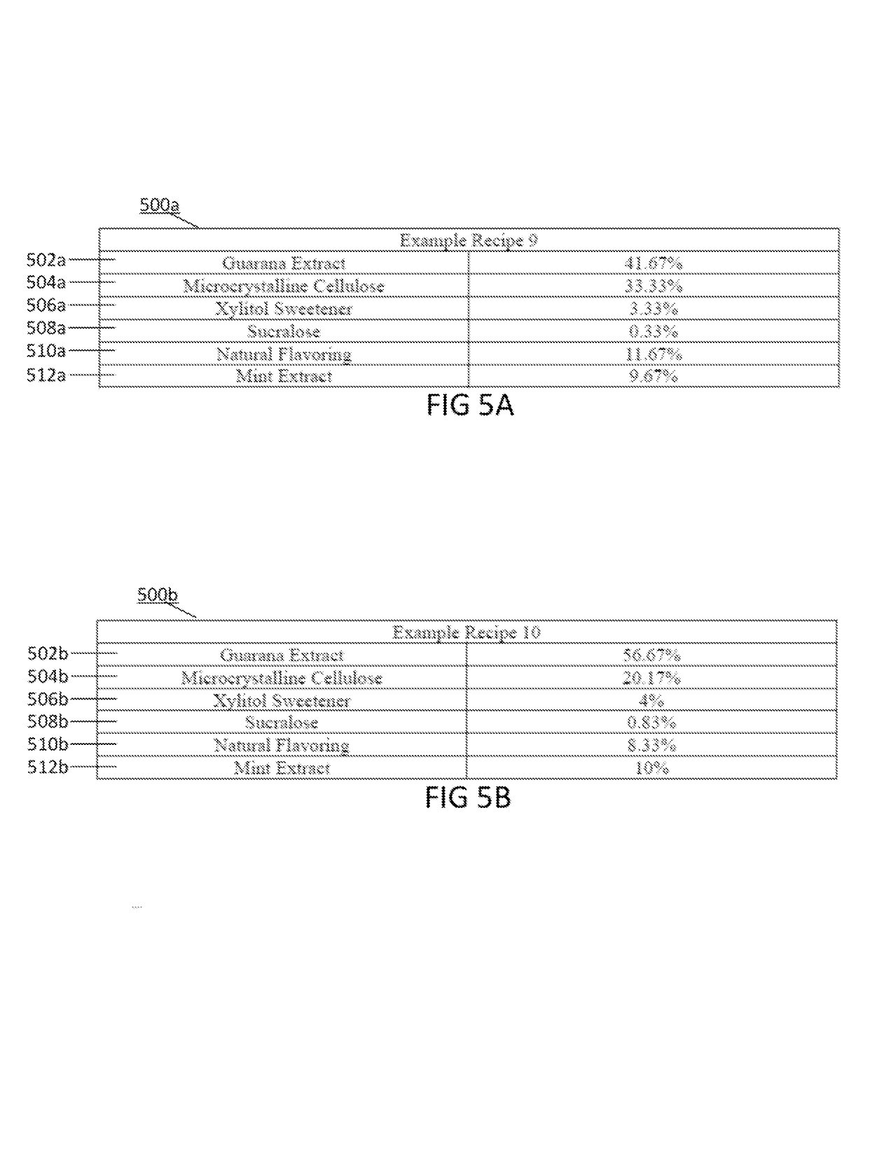

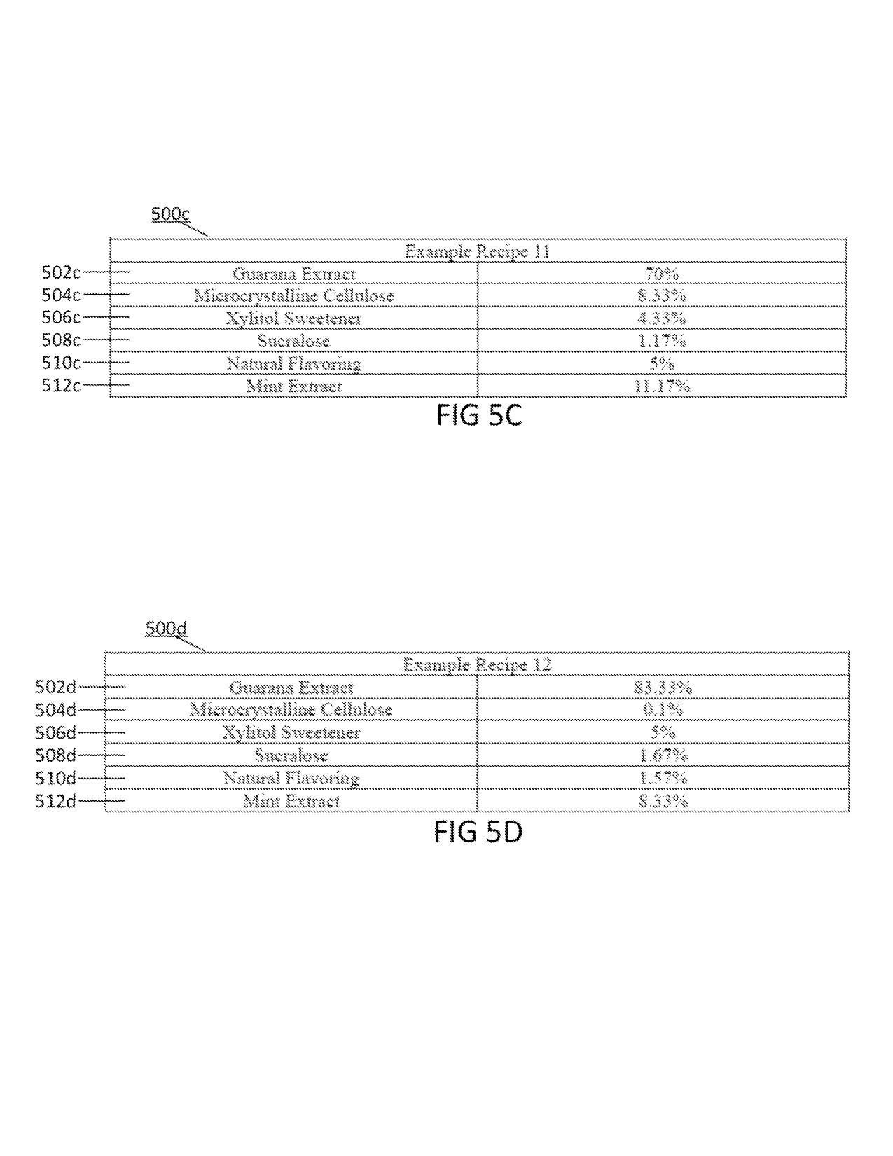

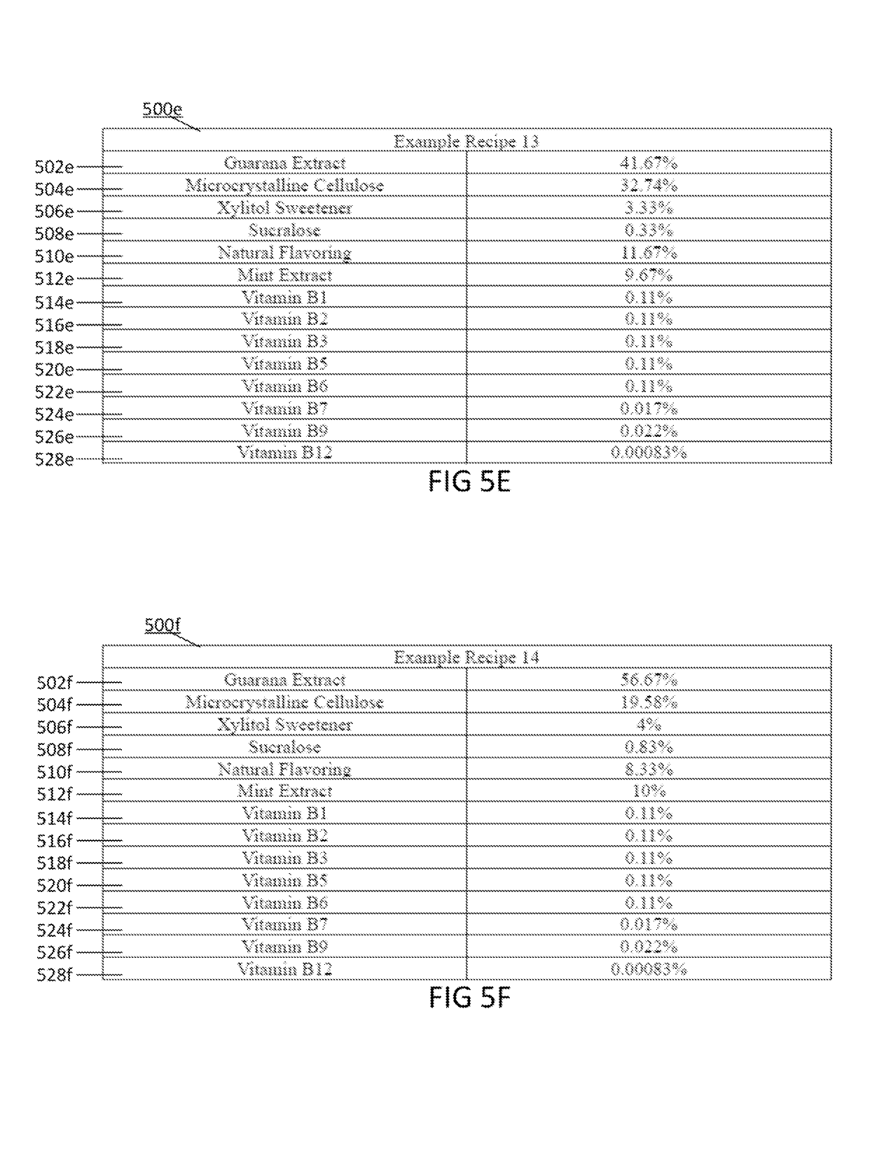

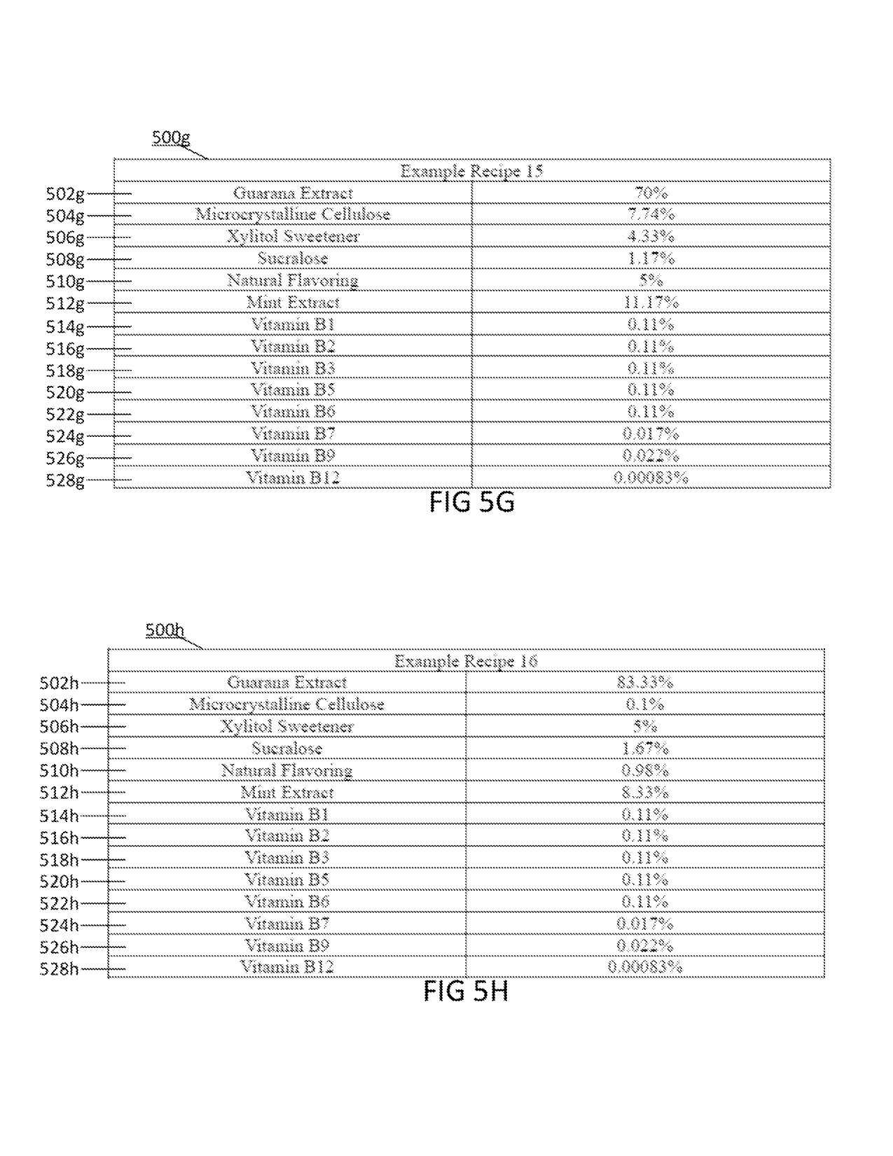

FIGS. 5A-5H depict a series of example recipes 500a, 500b, 500c, 500d, 500e, 500f, 500g, and 500h using the second set of ingredients 400.

As illustrated in FIG. 5A, a nineth example recipe 500a may include guarana extract 502a at about 41.67% of the total composition of the stimulant compound 102, microcrystalline cellulose 504a at about 33.33% of the total composition of the stimulant compound 102, xylitol sweetener 506a at about 3.33% of the total composition of the stimulant compound 102, sucralose 508a at about 0.33% of the total composition of the stimulant compound 102, natural flavoring 510a at about 11.67% of the total composition of the stimulant compound 102, and mint extract 512a at about 9.67% of the total composition of the stimulant compound 102.

As an illustrative example, an orally administered stimulant 100 following the nineth example recipe 500a may have a total dry weight of about 600mg. Under the nineth example recipe 500a, the guarana extract 502a would be about 250mg of the total dry weight of the stimulant compound 102, the microcrystalline cellulose 504a would be about 200mg of the total dry weight of the stimulant compound 102, the xylitol sweetener 506a would be about 20mg of the total dry weight of the stimulant compound 102, the sucralose 508a would be about 2mg of the total dry weight of the stimulant compound 102, the natural flavoring 510a would be about 70mg of the total dry weight of the stimulant compound 102, and the mint extract 512a at about 58mg of the total dry weight of the stimulant compound 102.

As illustrated in FIG. 5B, a tenth example recipe 500b may include guarana extract 502b at about 56.67% of the total composition of the stimulant compound 102, microcrystalline cellulose 504b at about 20.17% of the total composition of the stimulant compound 102, xylitol sweetener 506b at about 4% of the total composition of the stimulant compound 102, sucralose 508b at about 0.83% of the total composition of the stimulant compound 102, natural flavoring 510b at about 8.33% of the total composition of the stimulant compound 102, and mint extract 512b at about 10% of the total composition of the stimulant compound 102.

As an illustrative example, an orally administered stimulant 100 following the tenth example recipe 500b may have a total dry weight of about 600mg. Under the tenth example recipe 500b, the guarana extract 502b would be about 340mg of the total dry weight of the stimulant compound 102, the microcrystalline cellulose 504b would be about 121mg of the total dry weight of the stimulant compound 102, the xylitol sweetener 506b would be about 24mg of the total dry weight of the stimulant compound 102, the sucralose 508b would be about 5mg of the total dry weight of the stimulant compound 102, the natural flavoring 510b would be about 50mg of the total dry weight of the stimulant compound 102, and the mint extract 512b at about 60mg of the total dry weight of the stimulant compound 102.

As illustrated in FIG. 5C, an eleventh example recipe 500c may include guarana extract 502c at about 70% of the total composition of the stimulant compound 102, microcrystalline cellulose 504c at about 8.33% of the total composition of the stimulant compound 102, xylitol sweetener 506c at about 4.33% of the total composition of the stimulant compound 102, sucralose 508c at about 1.17% of the total composition of the stimulant compound 102, natural flavoring 510c at about 5% of the total composition of the stimulant compound 102, and mint extract 512c at about 11.17% of the total composition of the stimulant compound 102.

As an illustrative example, an orally administered stimulant 100 following the eleventh example recipe 500c may have a total dry weight of about 600mg. Under the eleventh example recipe 500c, the guarana extract 502c would be about 420mg of the total dry weight of the stimulant compound 102, the microcrystalline cellulose 504c would be about 50mg of the total dry weight of the stimulant compound 102, the xylitol sweetener 506c would be about 26mg of the total dry weight of the stimulant compound 102, the sucralose 508c would be about 7 mg of the total dry weight of the stimulant compound 102, the natural flavoring 510c would be about 30mg of the total dry weight of the stimulant compound 102, and the mint extract 512c at about 67mg of the total dry weight of the stimulant compound 102.

As illustrated in FIG. 5D, a twelfth example recipe 500d may include guarana extract 502d at about 83.33% of the total composition of the stimulant compound 102, microcrystalline cellulose 504d at about 0.1% of the total composition of the stimulant compound 102, xylitol sweetener 506d at about 5% of the total composition of the stimulant compound 102, sucralose 508d at about 1.67% of the total composition of the stimulant compound 102, natural flavoring 510d at about 1.57% of the total composition of the stimulant compound 102, and mint extract 512d at about 8.33% of the total composition of the stimulant compound 102.

As an illustrative example, an orally administered stimulant 100 following the twelfth example recipe 500d may have a total dry weight of about 600mg. Under the twelfth example recipe 500d, the guarana extract 502d would be about 500mg of the total dry weight of the stimulant compound 102, the microcrystalline cellulose 504d would be about 0.6mg of the total dry weight of the stimulant compound 102, the xylitol sweetener 506d would be about 30mg of the total dry weight of the stimulant compound 102, the sucralose 508d would be about 10mg of the total dry weight of the stimulant compound 102, the natural flavoring 510d would be about 9.4mg of the total dry weight of the stimulant compound 102, and the mint extract 512d at about 50mg of the total dry weight of the stimulant compound 102.

As illustrated in FIG. 5E, a thirteenth example recipe 500e may include guarana extract 502e at about 41.67% of the total composition of the stimulant compound 102, microcrystalline cellulose 504e at about 32.74% of the total composition of the stimulant compound 102, xylitol sweetener 506e at about 3.33% of the total composition of the stimulant compound 102, sucralose 508e at about 0.33% of the total composition of the stimulant compound 102, natural flavoring 510e at about 11.67% of the total composition of the stimulant compound 102, mint extract 512e at about 9.67% of the total composition of the stimulant compound 102, Vitamin B1 514e at about 0.11% of the total composition of the stimulant compound 102, Vitamin B2 516e at about 0.11% of the total composition of the stimulant compound 102, Vitamin B3 518e at about 0.11% of the total composition of the stimulant compound 102, Vitamin B5 520e at about 0.11% of the total composition of the stimulant compound 102, Vitamin B6 522e at about 0.11% of the total composition of the stimulant compound 102, Vitamin B7 524e at about 0.017% of the total composition of the stimulant compound 102, Vitamin B9 526e at about 0.022% of the total composition of the stimulant compound 102, and Vitamin B12 528e at about 0.00083% of the total composition of the stimulant compound 102.

As an illustrative example, an orally administered stimulant 100 following the thirteenth example recipe 500e may have a total dry weight of about 600mg. Under the thirteenth example recipe 500e, the guarana extract 502e would be about 250mg of the total dry weight of the stimulant compound 102, the microcrystalline cellulose 504e would be about 196.45mg of the total dry weight of the stimulant compound 102, the xylitol sweetener 506e would be about 20mg of the total dry weight of the stimulant compound 102, the sucralose 508e would be about 2mg of the total dry weight of the stimulant compound 102, the natural flavoring 510e would be about 70mg of the total dry weight of the stimulant compound 102, the mint extract 512e at about 58mg of the total dry weight of the stimulant compound 102, the Vitamin B1 514e at about 0.66mg of the total composition of the stimulant compound 102, the Vitamin B2 516e at about 0.66mg of the total composition of the stimulant compound 102, the Vitamin B3 518e at about 0.66mg of the total composition of the stimulant compound 102, the Vitamin B5 520e at about 0.66mg of the total composition of the stimulant compound 102, the Vitamin B6 522e at about 0.66mg of the total composition of the stimulant compound 102, the Vitamin B7 524e at about 0.1mg of the total composition of the stimulant compound 102, the Vitamin B9 526e at about 0.132mg of the total composition of the stimulant compound 102, and the Vitamin B12 528e at about 5mcg of the total composition of the stimulant compound 102.

As illustrated in FIG. 5F, a fourteenth example recipe 500f may include guarana extract 502f at about 56.67% of the total composition of the stimulant compound 102, microcrystalline cellulose 504f at about 19.58% of the total composition of the stimulant compound 102, xylitol sweetener 506f at about 4% of the total composition of the stimulant compound 102, sucralose 508f at about 0.83% of the total composition of the stimulant compound 102, natural flavoring 510f at about 8.33% of the total composition of the stimulant compound 102, mint extract 512f at about 10% of the total composition of the stimulant compound 102, Vitamin B1 514f at about 0.11% of the total composition of the stimulant compound 102, Vitamin B2 516f at about 0.11% of the total composition of the stimulant compound 102, Vitamin B3 518f at about 0.11% of the total composition of the stimulant compound 102, Vitamin B5 520f at about 0.11% of the total composition of the stimulant compound 102, Vitamin B6 522f at about 0.11% of the total composition of the stimulant compound 102, Vitamin B7 524f at about 0.017% of the total composition of the stimulant compound 102, Vitamin B9 526f at about 0.022% of the total composition of the stimulant compound 102, and Vitamin B12 528f at about 0.00083% of the total composition of the stimulant compound 102.

As an illustrative example, an orally administered stimulant 100 following the fourteenth example recipe 500f may have a total dry weight of about 600mg. Under the fourteenth example recipe 500f, the guarana extract 502f would be about 340mg of the total dry weight of the stimulant compound 102, the microcrystalline cellulose 504f would be about 117.48mg of the total dry weight of the stimulant compound 102, the xylitol sweetener 506f would be about 24mg of the total dry weight of the stimulant compound 102, the sucralose 508f would be about 5mg of the total dry weight of the stimulant compound 102, the natural flavoring 510f would be about 50mg of the total dry weight of the stimulant compound 102, the mint extract 512f at about 60mg of the total dry weight of the stimulant compound 102, the Vitamin B1 514f at about 0.66mg of the total composition of the stimulant compound 102, the Vitamin B2 516f at about 0.66mg of the total composition of the stimulant compound 102, the Vitamin B3 518f at about 0.66mg of the total composition of the stimulant compound 102, the Vitamin B5 520f at about 0.66mg of the total composition of the stimulant compound 102, the Vitamin B6 522f at about 0.66mg of the total composition of the stimulant compound 102, the Vitamin B7 524f at about 0.1mg of the total composition of the stimulant compound 102, the Vitamin B9 526f at about 0.132mg of the total composition of the stimulant compound 102, and the Vitamin B12 528f at about 5mcg of the total composition of the stimulant compound 102.

As illustrated in FIG. 5G, a fifteenth example recipe 500g may include guarana extract 502g at about 70% of the total composition of the stimulant compound 102, microcrystalline cellulose 504g at about 7.74% of the total composition of the stimulant compound 102, xylitol sweetener 506g at about 4.33% of the total composition of the stimulant compound 102, sucralose 508g at about 1.17% of the total composition of the stimulant compound 102, natural flavoring 510g at about 5% of the total composition of the stimulant compound 102, mint extract 512g at about 11.17% of the total composition of the stimulant compound 102, Vitamin B1 514g at about 0.11% of the total composition of the stimulant compound 102, Vitamin B2 516g at about 0.11% of the total composition of the stimulant compound 102, Vitamin B3 518g at about 0.11% of the total composition of the stimulant compound 102, Vitamin B5 520g at about 0.11% of the total composition of the stimulant compound 102, Vitamin B6 522g at about 0.11% of the total composition of the stimulant compound 102, Vitamin B7 524g at about 0.017% of the total composition of the stimulant compound 102, Vitamin B9 526g at about 0.022% of the total composition of the stimulant compound 102, and Vitamin B12 528g at about 0.00083% of the total composition of the stimulant compound 102.

As an illustrative example, an orally administered stimulant 100 following the fifteenth example recipe 500g may have a total dry weight of about 600mg. Under the fifteenth example recipe 500g, the guarana extract 502g would be about 420mg of the total dry weight of the stimulant compound 102, the microcrystalline cellulose 504g would be about 46.44mg of the total dry weight of the stimulant compound 102, the xylitol sweetener 506g would be about 26mg of the total dry weight of the stimulant compound 102, the sucralose 508g would be about 7mg of the total dry weight of the stimulant compound 102, the natural flavoring 510g would be about 30mg of the total dry weight of the stimulant compound 102, the mint extract 512g at about 67mg of the total dry weight of the stimulant compound 102, the Vitamin B1 514g at about 0.66mg of the total composition of the stimulant compound 102, the Vitamin B2 516g at about 0.66mg of the total composition of the stimulant compound 102, the Vitamin B3 518g at about 0.66mg of the total composition of the stimulant compound 102, the Vitamin B5 520g at about 0.66mg of the total composition of the stimulant compound 102, the Vitamin B6 522g at about 0.66mg of the total composition of the stimulant compound 102, the Vitamin B7 524g at about 0.1mg of the total composition of the stimulant compound 102, the Vitamin B9 526g at about 0.132mg of the total composition of the stimulant compound 102, and the Vitamin B12 528g at about 5mcg of the total composition of the stimulant compound 102.

As illustrated in FIG. 5H, a sixteenth example recipe 500h may include guarana extract 502h at about 83.33% of the total composition of the stimulant compound 102, microcrystalline cellulose 504h at about 0.1% of the total composition of the stimulant compound 102, xylitol sweetener 506h at about 5% of the total composition of the stimulant compound 102, sucralose 508h at about 1.67% of the total composition of the stimulant compound 102, natural flavoring 510h at about 0.98% of the total composition of the stimulant compound 102, mint extract 512h at about 8.33% of the total composition of the stimulant compound 102, Vitamin B1 514h at about 0.11% of the total composition of the stimulant compound 102, Vitamin B2 516h at about 0.11% of the total composition of the stimulant compound 102, Vitamin B3 518h at about 0.11% of the total composition of the stimulant compound 102, Vitamin B5 520h at about 0.11% of the total composition of the stimulant compound 102, Vitamin B6 522h at about 0.11% of the total composition of the stimulant compound 102, Vitamin B7 524h at about 0.017% of the total composition of the stimulant compound 102, Vitamin B9 526h at about 0.022% of the total composition of the stimulant compound 102, and Vitamin B12 528h at about 0.00083% of the total composition of the stimulant compound 102.

As an illustrative example, an orally administered stimulant 100 following the fifteenth example recipe 500h may have a total dry weight of about 600mg. Under the fifteenth example recipe 500h, the guarana extract 502h would be about 500mg of the total dry weight of the stimulant compound 102, the microcrystalline cellulose 504h would be about 0.6mg of the total dry weight of the stimulant compound 102, the xylitol sweetener 506h would be about 30mg of the total dry weight of the stimulant compound 102, the sucralose 508h would be about 10mg of the total dry weight of the stimulant compound 102, the natural flavoring 510h would be about 5.88mg of the total dry weight of the stimulant compound 102, the mint extract 512h at about 50mg of the total dry weight of the stimulant compound 102, the Vitamin B1 514h at about 0.66mg of the total composition of the stimulant compound 102, the Vitamin B2 516h at about 0.66mg of the total composition of the stimulant compound 102, the Vitamin B3 518h at about 0.66mg of the total composition of the stimulant compound 102, the Vitamin B5 520h at about 0.66mg of the total composition of the stimulant compound 102, the Vitamin B6 522h at about 0.66mg of the total composition of the stimulant compound 102, the Vitamin B7 524h at about 0.1mg of the total composition of the stimulant compound 102, the Vitamin B9 526h at about 0.132mg of the total composition of the stimulant compound 102, and the Vitamin B12 528h at about 5mcg of the total composition of the stimulant compound 102.

### ADDITIONAL CONSIDERATIONS

Although the text herein sets forth a detailed description of numerous different embodiments, it should be understood that the legal scope of the invention is defined by the words of the claims set forth at the end of this patent.

Throughout this specification, plural instances may implement components, operations, or structures described as a single instance. Although individual operations of one or more methods or methods of manufacture are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Similarly, the methods or routines described herein may be at least partially machine-implemented or processor-implemented. For example, at least some of the operations of a method may be performed by one or more processors or processor-implemented modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

As used herein any reference to “some embodiments” means that a particular element, feature, structure, or characteristic described in connection with the embodiment may be included in at least one embodiment. The appearances of the phrase “some embodiments” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, apparatus, or composition that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for the systems and methods disclosed herein.

Thus, while particular embodiments and applications have been illustrated and described, it is to be understood that the disclosed embodiments are not limited to the precise construction and components disclosed herein. Various modifications, changes and/or variations, which will be apparent to those skilled in the art, may be made in the arrangement, operation and/or details of the methods, apparatuses, and/or compositions disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

What is claimed is:

1. An orally administered stimulant comprising:
at least 30% of guarana extract;
at least 0.1% of polyvinylpyrrolidone;
at least 0.1% of xylitol sweetener;
at least 0.1% of sucralose;
at least 0.1% of natural flavoring; and
at least 0.1% of mint extract,
wherein the orally administered stimulant is fully mixed into a homogonous solution and dried to form a powder.

2. The orally administered stimulant of claim 1, wherein:
the guarana extract equals about 41.67% of the orally administered stimulant;
the polyvinylpyrrolidone equals about 33.33% of the orally administered stimulant;
the xylitol sweetener equals about 3.33% of the orally administered stimulant;
the sucralose equals about 0.33% of the orally administered stimulant;
the natural flavoring equals about 11.67% of the orally administered stimulant; and
the mint extract equals about 9.67% of the orally administered stimulant.

3. The orally administered stimulant of claim 1, wherein:
the guarana extract equals about 56.67% of the orally administered stimulant;
the polyvinylpyrrolidone equals about 20.17% of the orally administered stimulant;
the xylitol sweetener equals about 4% of the orally administered stimulant;
the sucralose equals about 0.83% of the orally administered stimulant;
the natural flavoring equals about 8.33% of the orally administered stimulant; and
the mint extract equals about 10% of the orally administered stimulant.

4. The orally administered stimulant of claim 1, wherein:
the guarana extract equals about 83.33% of the orally administered stimulant;
the polyvinylpyrrolidone equals about 0.1% of the orally administered stimulant;
the xylitol sweetener equals about 5% of the orally administered stimulant;
the sucralose equals about 1.67% of the orally administered stimulant;
the natural flavoring equals about 1.57% of the orally administered stimulant; and
the mint extract equals about 8.33% of the orally administered stimulant.

5. The orally administered stimulant of claim 1, the orally administered stimulant further comprising:
at least 0.1% of Vitamin B1;
at least 0.1% of Vitamin B2;
at least 0.1% of Vitamin B3;
at least 0.1% of Vitamin B5;
at least 0.1% of Vitamin B6;
at least 0.01% of Vitamin B7;
at least 0.01% of Vitamin B9; and
at least 0.0001% of Vitamin B12.

6. The orally administered stimulant of claim 5, wherein:
the guarana extract equals about 41.67% of the orally administered stimulant;
the polyvinylpyrrolidone equals about 32.74% of the orally administered stimulant;
the xylitol sweetener equals about 3.33% of the orally administered stimulant;
the sucralose equals about 0.33% of the orally administered stimulant;
the natural flavoring equals about 11.67% of the orally administered stimulant;
the mint extract equals about 9.67% of the orally administered stimulant;
the Vitamin B1 equals about 0.11% of the orally administered stimulant;
the Vitamin B2 equals about 0.11% of the orally administered stimulant;
the Vitamin B3 equals about 0.11% of the orally administered stimulant;
the Vitamin B5 equals about 0.11% of the orally administered stimulant;
the Vitamin B6 equals about 0.11% of the orally administered stimulant;
the Vitamin B7 equals about 0.017% of the orally administered stimulant;
the Vitamin B9 equals about 0.022% of the orally administered stimulant; and
the Vitamin B12 equals about 0.00083% of the orally administered stimulant.

7. The orally administered stimulant of claim 5, wherein:
the guarana extract equals about 56.67% of the orally administered stimulant;
the polyvinylpyrrolidone equals about 19.58% of the orally administered stimulant;
the xylitol sweetener equals about 4% of the orally administered stimulant;
the sucralose equals about 0.83% of the orally administered stimulant;
the natural flavoring equals about 8.33% of the orally administered stimulant;
the mint extract equals about 10% of the orally administered stimulant;
the Vitamin B1 equals about 0.11% of the orally administered stimulant;
the Vitamin B2 equals about 0.11% of the orally administered stimulant;
the Vitamin B3 equals about 0.11% of the orally administered stimulant;
the Vitamin B5 equals about 0.11% of the orally administered stimulant;
the Vitamin B6 equals about 0.11% of the orally administered stimulant;
the Vitamin B7 equals about 0.017% of the orally administered stimulant;
the Vitamin B9 equals about 0.022% of the orally administered stimulant; and
the Vitamin B12 equals about 0.00083% of the orally administered stimulant.

8. The orally administered stimulant of claim 5, wherein:
the guarana extract equals about 83.33% of the orally administered stimulant;
the polyvinylpyrrolidone equals about 0.1% of the orally administered stimulant;
the xylitol sweetener equals about 5% of the orally administered stimulant;
the sucralose equals about 1.67% of the orally administered stimulant;
the natural flavoring equals about 0.98% of the orally administered stimulant;
the mint extract equals about 8.33% of the orally administered stimulant;
the Vitamin B1 equals about 0.11% of the orally administered stimulant;
the Vitamin B2 equals about 0.11% of the orally administered stimulant;
the Vitamin B3 equals about 0.11% of the orally administered stimulant;
the Vitamin B5 equals about 0.11% of the orally administered stimulant;
the Vitamin B6 equals about 0.11% of the orally administered stimulant;
the Vitamin B7 equals about 0.017% of the orally administered stimulant;
the Vitamin B9 equals about 0.022% of the orally administered stimulant; and
the Vitamin B12 equals about 0.00083% of the orally administered stimulant.

9. The orally administered stimulant of claim 1, wherein the powder form of the orally administered stimulant is encased in a water insoluble pouch, the water insoluble pouch is permeable for saliva, and the water insoluble pouch is made from non-toxic viscose.

10. The orally administered stimulant of claim 1, wherein the orally administered stimulant, when orally administered to a user, freshens the user’s breath and does not stain the user’s teeth.

11. An orally administered stimulant comprising:
at least 30% of guarana extract;
at least 1% of microcrystalline cellulose;
at least 1% of xylitol sweetener;
at least 0.1% of sucralose;
at least 1% of natural flavoring; and
at least 5% of mint extract,
wherein the orally administered stimulant is fully mixed into a homogonous solution and dried to form a powder.

12. The orally administered stimulant of claim 11, wherein:
the guarana extract equals about 41.67% of the orally administered stimulant;
the microcrystalline cellulose equals about 33.33% of the orally administered stimulant;
the xylitol sweetener equals about 3.33% of the orally administered stimulant;
the sucralose equals about 0.33% of the orally administered stimulant;
the natural flavoring equals about 11.67% of the orally administered stimulant; and
the mint extract equals about 9.67% of the orally administered stimulant.

13. The orally administered stimulant of claim 11, wherein:
the guarana extract equals about 56.67% of the orally administered stimulant;
the microcrystalline cellulose equals about 20.17% of the orally administered stimulant;
the xylitol sweetener equals about 4% of the orally administered stimulant;
the sucralose equals about 0.83% of the orally administered stimulant;
the natural flavoring equals about 8.33% of the orally administered stimulant; and
the mint extract equals about 10% of the orally administered stimulant.

14. The orally administered stimulant of claim 11, wherein:
the guarana extract equals about 83.33% of the orally administered stimulant;
the microcrystalline cellulose equals about 0.1% of the orally administered stimulant;
the xylitol sweetener equals about 5% of the orally administered stimulant;
the sucralose equals about 1.67% of the orally administered stimulant;
the natural flavoring equals about 1.57% of the orally administered stimulant; and
the mint extract equals about 8.33% of the orally administered stimulant.

15. The orally administered stimulant of claim 11, the orally administered stimulant further comprising:
at least 0.1% of Vitamin B1;
at least 0.1% of Vitamin B2;
at least 0.1% of Vitamin B3;
at least 0.1% of Vitamin B5;
at least 0.1% of Vitamin B6;
at least 0.01% of Vitamin B7;
at least 0.01% of Vitamin B9; and
at least 0.0001% of Vitamin B12.

16. The orally administered stimulant of claim 15, wherein:
the guarana extract equals about 41.67% of the orally administered stimulant;
the microcrystalline cellulose equals about 32.74% of the orally administered stimulant;
the xylitol sweetener equals about 3.33% of the orally administered stimulant;
the sucralose equals about 0.33% of the orally administered stimulant;
the natural flavoring equals about 11.67% of the orally administered stimulant;
the mint extract equals about 9.67% of the orally administered stimulant;
the Vitamin B1 equals about 0.11% of the orally administered stimulant;
the Vitamin B2 equals about 0.11% of the orally administered stimulant;
the Vitamin B3 equals about 0.11% of the orally administered stimulant;
the Vitamin B5 equals about 0.11% of the orally administered stimulant;
the Vitamin B6 equals about 0.11% of the orally administered stimulant;
the Vitamin B7 equals about 0.017% of the orally administered stimulant;
the Vitamin B9 equals about 0.022% of the orally administered stimulant; and
the Vitamin B12 equals about 0.00083% of the orally administered stimulant.

17. The orally administered stimulant of claim 15, wherein:
the guarana extract equals about 56.67% of the orally administered stimulant;
the microcrystalline cellulose equals about 19.58% of the orally administered stimulant;
the xylitol sweetener equals about 4% of the orally administered stimulant;
the sucralose equals about 0.83% of the orally administered stimulant;
the natural flavoring equals about 8.33% of the orally administered stimulant;
the mint extract equals about 10% of the orally administered stimulant;
the Vitamin B1 equals about 0.11% of the orally administered stimulant;
the Vitamin B2 equals about 0.11% of the orally administered stimulant;
the Vitamin B3 equals about 0.11% of the orally administered stimulant;
the Vitamin B5 equals about 0.11% of the orally administered stimulant;
the Vitamin B6 equals about 0.11% of the orally administered stimulant;
the Vitamin B7 equals about 0.017% of the orally administered stimulant;
the Vitamin B9 equals about 0.022% of the orally administered stimulant; and
the Vitamin B12 equals about 0.00083% of the orally administered stimulant.

18. The orally administered stimulant of claim 15, wherein:
the guarana extract equals about 83.33% of the orally administered stimulant;
the microcrystalline cellulose equals about 0.1% of the orally administered stimulant;
the xylitol sweetener equals about 5% of the orally administered stimulant;
the sucralose equals about 1.67% of the orally administered stimulant;
the natural flavoring equals about 0.98% of the orally administered stimulant;
the mint extract equals about 8.33% of the orally administered stimulant;
the Vitamin B1 equals about 0.11% of the orally administered stimulant;
the Vitamin B2 equals about 0.11% of the orally administered stimulant;
the Vitamin B3 equals about 0.11% of the orally administered stimulant;
the Vitamin B5 equals about 0.11% of the orally administered stimulant;
the Vitamin B6 equals about 0.11% of the orally administered stimulant;
the Vitamin B7 equals about 0.017% of the orally administered stimulant;
the Vitamin B9 equals about 0.022% of the orally administered stimulant; and
the Vitamin B12 equals about 0.00083% of the orally administered stimulant.

19. The orally administered stimulant of claim 11, wherein the powder form of the orally administered stimulant is encased in a water insoluble pouch, the water insoluble pouch is permeable for saliva, and the water insoluble pouch is made from non-toxic viscose.

20. The orally administered stimulant of claim 11, wherein the orally administered stimulant, when orally administered to a user, freshens the user’s breath and does not stain the user’s teeth.
